(19) United States
(12) Patent Application Publication
(10) Pub. No.: US 2022/0332132 A1
(43) Pub. Date: Oct. 20, 2022

(54) ADJUSTMENT OF TENSION APPLIED TO ROLL OF SUBSTRATE

(71) Applicant: Hewlett-Packard Development Company, L.P., Spring, TX (US)

(72) Inventors: Martin Urrutia Nebreda, Sant Cugat del Valles (ES); Josep Maria Bel Calavia, Sant Cugat del Valles (ES); Eduard Lores Garcia, Sant Cugat del Valles (ES)

(21) Appl. No.: 17/232,813

(22) Filed: Apr. 16, 2021

(51) Int. Cl. B41J 15/16; B65H 16/10; B65H 23/185

(52) U.S. Cl. CPC B41J 15/16; B65H 16/10; B65H 23/185

(57) ABSTRACT

A printing device includes a supply roller on which a roll of substrate is wound, and a tension motor to apply a tension to the roll of substrate. The printing device includes a drive roller to advance the substrate from the roll through a print zone, a drive roller motor to rotate the drive roller, and a drive roller motor controller to apply a drive roller motor signal to the drive roller motor. The printing device includes a closed loop tension controller to adjust the tension applied by the tension motor to the roll of substrate based on the drive roller motor signal applied to the drive roller motor.

### BACKGROUND

Printing devices print on print substrate to form images on the substrate by outputting print material onto the substrate. For example, the print material can include ink and the print substrate can include paper. Some types of printing devices use print substrate in the form of substrate rolls. A roll of substrate is wound on a supply roller, and unwound and advanced through a print zone within which print material is output onto the substrate. The substrate may then be wound on a take-up roll in some cases.

### BRIEF DESCRIPTION OF THE DRAWINGS

FIG. 1 is a diagram of an example printing device in which tension applied to a substrate roll can be adjusted in a closed loop manner without using a tension sensor or otherwise directly measuring or monitoring substrate tension.

FIG. 2 is a diagram of an example process by which substrate roll tension can be adjusted in the printing device of FIG. 1 based on a signal applied to a drive roller motor to advance the print substrate.

FIG. 3 is a diagram of an example process by which substrate roll tension can be adjusted in the printing device of FIG. 1 based on a dynamic media factor (DMF) that compensates for print substrate slippage.

FIG. 4 is a diagram of an example process by which substrate roll tension can be adjusted in the printing device of FIG. 1 based both on a drive roller motor signal and a DMF.

FIG. 5 is a diagram of an example tension motor controller.

### DETAILED DESCRIPTION

As noted in the background, a printing device can employ a substrate roll from which the substrate is unwound and advanced through a print zone within which ink or other print material is output onto the substrate to form images on the substrate. To ensure proper advancement of the substrate and thus to ensure optimal image quality, a tension motor may apply a tension to the substrate roll as wound on a supply roller. That is, the tension motor applies a force to the supply roller in the rotational direction opposite to which the roller rotates when the substrate is unwound for advancement through the print zone. Specifically, a voltage is applied to the tension motor in accordance with the tension to be applied to the roll of substrate.

The tension that should be applied to the substrate roll varies based on characteristics of the print substrate. Furthermore, the voltage applied to the tension motor to realize or yield the target tension varies based on dynamics of movement of the print substrate through the printing device and frictional considerations within the printing device, in addition to the actual tension on the substrate roll. While such parameters can be calibrated, during the printing process errors can be introduced into the voltage calculation process. For example, such errors can result from the decreasing radius of the substrate roll as the print substrate is advanced from the roll, as well as due to eccentricity of the roll itself (i.e., the roll not being perfectly circular in cross section).

Techniques described herein provide for substrate roll tension adjustment in a closed loop manner without employing a tension sensor or otherwise directly measuring or monitoring substrate tension. Rather, existing sensors and other components of a printing device that can provide indirect indication of actual substrate tension are leveraged. For example, the drive roller of a printing device that advances the substrate from a substrate roll through the print zone may be controlled by a servomotor to which a signal is applied to realize a specified drive roller speed. The signal may be a voltage signal or a pulse-width modulation (PWM) signal, for instance. Because the signal applied to realize a given substrate advancement speed changes in part due to substrate tension, such signal changes can be indirectly indicative of corresponding changes in tension.

A printing device may also have an advance sensor that detects actual advancement of the print substrate through the print zone. In conjunction with a drive roller encoder that detects rotation of the drive roller, print substrate slippage can be detected. The voltage applied to the servomotor may thus be corrected by a corresponding dynamic media factor (DMF) to compensate for such substrate slippage. For example, if based on the driver roller rotation the substrate is expected to advance 10 millimeters (mm) but the advance sensor detects that the substrate has advanced 9.5 mm, a compensating DMF may be applied to increase the drive roller motor voltage. Because substrate slippage can occur in part due to substrate tension, changes in DMF can also indirectly indicate corresponding tension changes.

In both of these ways, therefore, closed loop substrate tension adjustment can be provided within a printing device without directly measuring tension. Rather, a drive roller motor signal, such as a voltage or PWM signal, can be monitored as a way to provide feedback to a tension motor controller that controls the voltage applied to the tension motor to control substrate. Similarly, if the printing device includes an advance sensor, DMF can be monitored as a way to provide feedback to the tension motor controller in controlling the voltage applied by the tension motor to control substrate tension. Although neither the drive roller motor signal nor DMF is directly indicative of substrate tension, each changes as tension changes, and therefore is indirectly indicative of substrate tension.

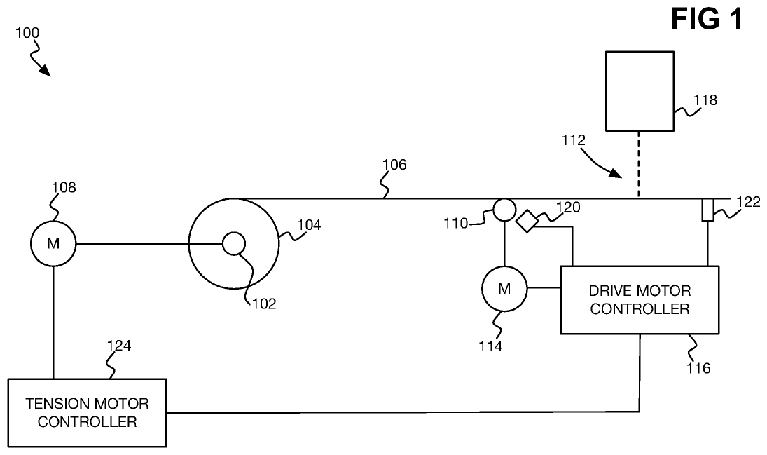

FIG. 1 shows an example printing device 100 in which substrate tension can be adjusted in a closed loop manner without using a tension sensor or otherwise directly measuring or monitoring substrate tension. The printing device 100 can be part of or more generally be a printing system, and includes a supply roller 102 on which a roll 104 of substrate 106 is wound. The printing device 100 includes a tension motor 108 that applies tension to the substrate roll 104, and a drive roller 110 that advances the substrate 106 from the roll 104 through a print zone 112. The printing device 100 includes a drive roller motor 114, such as a servomotor, that rotates the drive roller 110 to advance the substrate 106, and a drive roller motor controller 116 that applies a drive roller motor signal, such as a voltage or PWM signal, to the drive roller motor 114 to control rotation of the drive roller 110 and thus advancement of the substrate 106.

The printing device 100 includes a print mechanism 118 that outputs print material on the substrate 106 as the substrate 106 is advanced through the print zone 112. The print mechanism 118 may include a pagewide array (PWA) of inkjet printheads that eject ink (as the print material) on the substrate 106 as the substrate 106 is advanced through the print zone 112. The print mechanism 118 may instead include one or multiple scanning printheads mounted on a carriage and that eject ink on the substrate 106 as they scan along an axis perpendicular to the axis of advancement of the substrate 106 through the print zone 112. The print mechanism 118 may include a different type of print hardware as well, and may output print material other than ink, too.

The printing device 100 includes a drive roller encoder 120 that detects and thus measures rotation and thus rotational speed of the drive roller 110, and may also include an advance sensor 122, such as an optical sensor, that detects actual advancement of the substrate 106 through and past the print zone 112. The printing device 100 includes a closed loop tension motor controller 124 that applies a tension motor voltage to the tension motor 108 to control the tension applied by the tension motor 108 to the substrate roll 104. The tension motor 108 applies a force to the supply roller 102 on which the substrate roll 104 is wound in a direction of rotation opposite the direction of rotation of the drive roller 110 that advances the substrate 106 from the substrate roll 104 through the print zone 112.

The printing device 100 may not include a tension sensor by which tension on the substrate 106 can be directly detected or measured. That is, the printing device 100 does not receive a directly measured signal that is indicative of the actual substrate tension. However, the tension motor controller 124 is still able to adjust the tension applied by the tension motor 108 to the substrate roll 102 in a closed loop manner, based on information provided by the drive motor controller 116 that is indirectly indicative of substrate tension. Therefore, the voltage that the tension motor controller 124 applies to the tension motor 108 to control substrate tension can be adjusted based on a target tension that is adjusted using information provided by the drive motor controller 116 as feedback indirectly indicative of substrate tension.

Each of the drive motor controller 116 and the tension motor controller 124 can more generally be considered a controller device, and can be or include a processor and a non-transitory computer-readable data storage medium storing program code executable by the processor. The processor and the medium may be discrete components as is the case with a general-purpose processor and a memory, or may be integrated as one component as is the case with an application-specific integrated circuit (ASIC). The printing device 100 can include other components in addition to or in lieu of those depicted in FIG. 1, such as a take-up roller onto which the substrate 106 is wound after having been printed on in the print zone 112. The substrate 106 itself may be paper or another type of print substrate.

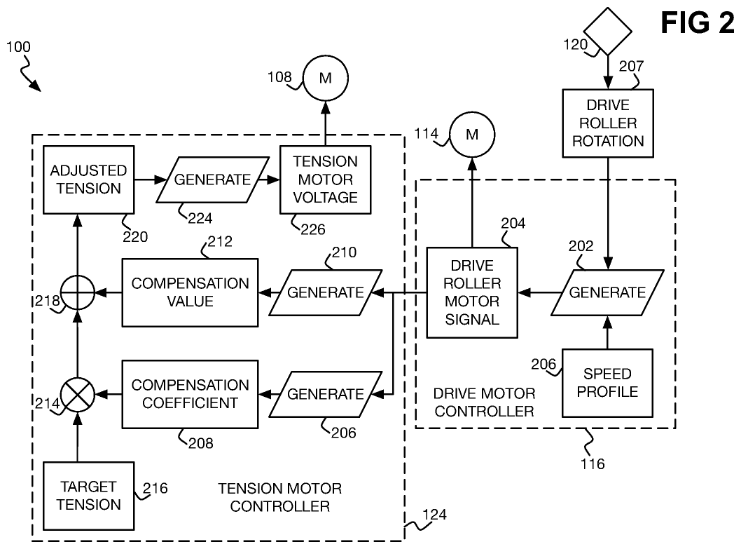

FIG. 2 shows an example process by which substrate roll tension can be adjusted in the printing device 100 of FIG. 1, specifically based on drive roller motor signal 204. The drive motor controller 116 at first generates (202) the signal 204, which may be a voltage signal or a PWM signal, based on a speed profile 206 to realize a specified drive roller speed. The speed profile 206 can be in the form of a table, and indicates the signal 204 that should be applied to the drive roller motor 114 to realize a specified speed for a given substrate type, as the substrate roll 104 is unwound from the supply roller 102 and advanced over time. The drive motor controller 116 applies the generated drive roller motor signal 204 to the drive roller motor 114.

However, the actual drive roller speed may differ from the specified speed, due to substrate tension. The drive motor controller 116 therefore receives feedback from the drive roller encoder 120 in the form of the actual drive roller rotation 207 of the drive roller 110. The drive roller rotation 207 is indicative of both the amount of rotation of the drive roller 110 as well as the speed of rotation. From this information and the original signal specified by the speed profile 206, the drive motor controller 116 can thus regenerate (202), or adjust, the drive roller motor signal 204 applied to the drive roller motor 114 in a closed loop manner to ensure that the rotational speed of the drive roller 110 remains constant and at least substantially equal to the specified speed.

The drive roller motor signal 204 is thus indirectly indicative of substrate tension. The tension motor controller 124 can therefore use the drive roller motor signal 204 to control the substrate tension applied by the tension motor 108 to the substrate roll 104. The tension motor controller 124 can generate (206) a compensation coefficient 208 based on the drive roller motor signal 204 received from the drive motor controller 116, and may instead or also generate (210) a compensation value 212 based on the drive roller motor signal 204.

The compensation coefficient 208 may compensate for tension variability resulting from a change (e.g., a decrease) in the radius of the substrate roll 104 as the substrate 106 is unwound from the roll 104 and advanced by the drive roller 110. The compensation value 212 may compensate for periodic tension variability resulting from eccentricity of the substrate roll 104. Such variability is periodic in accordance with every full rotation of the roll 104. The tension motor controller 124 can multiply (214) a specified target tension 216 to be applied to the substrate roll 104 by the compensation coefficient 208, and then add (218) the compensation value 212 to realize or yield the adjusted tension 220. The substrate tension 220 is thus adjusted or controlled in a closed loop manner in which the drive roller motor signal 204 is used as feedback indirectly indicative of actual substrate tension.

The tension motor controller 124 generates (224) the tension motor voltage 226 to be applied to the tension motor 108 to realize or yield the adjusted tension 220 on the substrate roll 104, and applies the generated tension motor voltage 226 to the tension motor 108. For example, the tension motor controller 124 may look up the tension motor voltage 226 within a table or other profile that specifies for the type of tension motor 108 and the type of substrate roll 104 the tension motor voltage 226 to be applied. The tension motor voltage 226 may be generated from the adjusted substrate tension 220 in another way as well.

The compensation coefficient 208 that compensates for tension variability resulting from the change in the substrate roll radius over time can be calculated in one implementation each time the drive roller 110 is advanced as follows. A drive roller motor 114 is specifically considered that is controlled via PWM, as opposed to voltage or another type of signal. The higher the actual substrate tension, the larger the resulting PWM to realize a specified drive roller motor speed. Furthermore, a filter can be used to smooth the PWM signal to compensate for sudden positive or negative spikes in PWM.

Specifically, the compensation coefficient 208 may be calculated as τ_{coeff}=1−K_{PWM}×(PWM_{filtered}−PWM₀). In this equation, τ_{coeff} is the compensation coefficient 208, K_{PWM} is a parameter that relates the compensation coefficient 208 with PWM variation, PWM_{filtered} is the filtered PWM value (i.e., the value of the drive roller motor signal 204) calculated based on the prior advancement of the drive roller 110, and PWM₀ is the initial PWM value used to first advance the roller 110 at the start of a print job. The filtered PWM value may itself be calculated as PWM_{filtered}=β×PWMₗₐₛₜ+(1−β)×PWM_{filtered}. In this equation, β is the weight given to the immediately prior PWM value, PWMₗₐₛₜ. Therefore, each time the drive roller 110 is advanced, the filtered PWM value is updated per this equation in order to determine the compensation coefficient 208. (It is noted that if the PWM signal is not filtered, then PWM_{filtered} may be replaced by PWMₗₐₛₜ in the equation by which τ_{coeff} is calculated.)

The compensation value 210 that compensates for periodic tension variability resulting from substrate roll eccentricity can be calculated in one implementation at each angular position of the supply roller 102 as follows. Because the compensation value 210 varies cyclically, the PWM values are fit to a sinusoidal curve so that the compensation value 210 can be linked to the angular position of the supply roller 102. That is, the period of tension variability is the period of the supply roller 102, and thus 360 degrees, or 27r radians. As such, just phase and amplitude have to be adjusted in order to determine the compensation value 210.

Specifically, the compensation value 210 may be calculated as τᵥₐₗ=A_{PWM}×sin(α_{rew}+ψ_{PWM}). In this equation, τᵥₐₗ is the compensation value 210, A_{PWM} is the amplitude of the sinusoidal tension adjustment, α_{rew} is the angular position of the supply roller 102, and ψ_{PWM} is the phase of the sinusoidal tension adjustment. The PWM signal (i.e., the drive roller motor signal 204) is algorithmically fitted to a sinusoidal curve as PWM_{fit}=PWM₀+[A_{fit}×sin(α_{rew}+ψ_{fit})], where PWM₀ is the initial PWM value used to first advance the roller 110 at the start of a print job as before, A_{fit} is the amplitude resulting from the fitting process, and ψ_{fit} is the phase resulting from the fitting process. Therefore, the amplitude of the sinusoidal tension adjustment can be calculated as A_{PWM}=σ_{fit}×KA_{fit}×A_{fit}, where σ_{fit} is the confidence of the fitting of the PWM signal to the sinusoidal curve and KA_{fit} is the parameter that relates the compensation value 210 to the PWM amplitude. The phase of the sinusoidal tension adjustment can be calculated as ψ_{PWM}=π−ψ_{fit}.

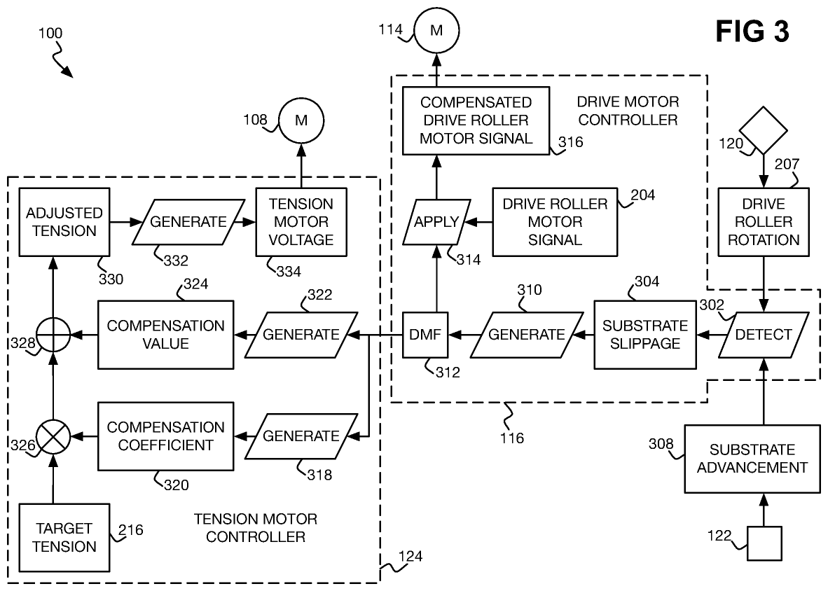

FIG. 3 shows an example process by which substrate roll tension can be adjusted in the printing device 100 of FIG. 1, specifically based on a DMF 312 that compensates for print substrate slippage 304. The drive motor controller 116 detects (302) the actual substrate slippage 304 based on the drive roller rotation 207 detected by the drive roller encoder 120, and the actual substrate advancement 308 measured or monitored by the advance sensor 122. For a given amount of rotation 207 of the drive roller 110, the print substrate 106 is expected to advance by a corresponding amount. Therefore, if the actual advancement 308 of the substrate 106 varies from the expected advancement for the actual amount of drive roller rotation 207, substrate slippage 304 has occurred.

To compensate for detected substrate slippage 304, the drive motor controller 116 generates (310) the DMF 312. The drive motor controller 116 may look up the DMF 312 for the print substrate slippage 304 within a table, or may otherwise generate the DMF 312 for the substrate slippage 304. The drive motor controller 116 then applies (314) (e.g., multiplies by) the DMF 312 to the drive roller motor signal 204, which can be generated as has been described in relation FIG. 2, to realize a compensated drive roller motor signal 316 that the controller 116 applies to the drive roller motor 114 to advance the drive roller 110 without slippage.

Print substrate slippage 304, and thus the resultantly generated DMF 312, can occur due to substrate tension. For example, with increased tension, increased substrate slippage 304 can occur, such that an increased DMF 312 is generated to compensate for the slippage 304 in the drive roller signal 316 applied to the drive roller motor 114. The DMF 312 is thus indirectly indicative of substrate tension, and the tension motor controller 124 can therefore use the DMF 312 to control the substrate tension applied by the tension motor 108 to the substrate roll 104.

The tension motor controller 124 can generate (318) a compensation coefficient 320 based on the DMF 312 received from the drive motor controller 116, and may instead or also generate (322) a compensation value 324 based on the DMF 312. As with the compensation coefficient 208 of FIG. 2, the compensation coefficient 320 may compensate for tension variability resulting from the change in radius of the substrate roll 104 over time. Similarly, as with the compensation value 212 of FIG. 2, the compensation value 324 may compensate for periodic tension variability resulting from substrate roll eccentricity.

The tension motor controller 124 can multiply (326) the target tension 216 to be applied to the substrate roll 104 by the compensation coefficient 320, and then add (328) the compensation value 324 to realize or yield the adjusted substrate tension 330. The substrate tension 330 is thus adjusted or controlled in a closed loop manner in which the DMF 312 is used as feedback indirectly indicative of actual substrate tension. The tension motor controller 124 then generates (332) the tension motor voltage 334 from the adjusted tension 330, and applies the generated voltage 334 to the tension motor 108, as in FIG. 2.

The compensation coefficient 320 and the compensation value 324 can be calculated in a manner similar to that which has been described in relation to FIG. 2 for the compensation coefficient 208 and the compensation value 212. The PWM values used in the equations (e.g., PWM_{filtered}, PWM₀, and PWMₗₐₛₜ) are replaced by DMF values to calculate the compensation coefficient 320 and the compensation value 324, and likewise the PWM fitted curve (e.g., PWM_{fit}) is replaced by a DMF fitted curve. Furthermore, the various parameters, weights, and confidences particular to PWM (e.g., K_{PWM}, β, σ_{fit}, and KA_{fit}) are replaced by weights particular to DMF.

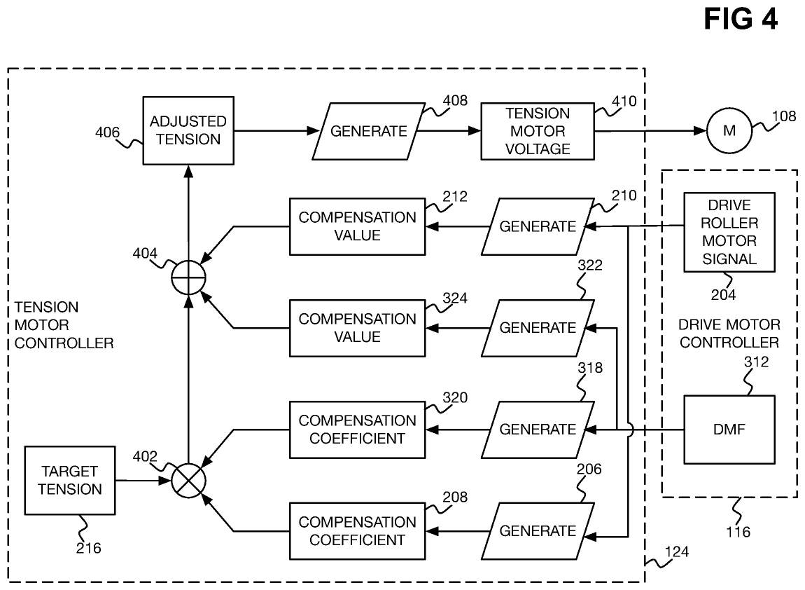

FIG. 4 shows an example process by which substrate roll tension can be adjusted in the printing device 100 of FIG. 1, based on both the drive roller motor signal 204 as in FIG. 2 and the DMF 312 as in FIG. 3. The tension motor controller 124 receives from the drive motor controller 116 both the drive roller motor signal 204 generated per FIG. 2 and the DMF 312 generated per FIG. 3. As in FIG. 2, a compensation coefficient 208 is generated (206) based on the drive roller motor signal 204, as is (210) a compensation value 212. Similarly, as in FIG. 3, a compensation coefficient 320 is generated (318) based on the DMF 312, as is (322) a compensation value 324.

The tension motor controller 124 then multiplies (402) the specified target tension 216 for the substrate roll 104 by the compensation coefficients 208 and 320. The compensation values 212 and 324 are added (404) to the resulting multiplicative product to realize or yield the adjusted substrate tension 406. The adjusted tension 406 is thus calculated in a closed loop manner, using both the drive roller motor signal 204 and the DMF 312 as feedback. The tension motor controller 124 generates (408) a tension motor voltage 410 from the adjusted tension 406 as has been described, and applies the generated tension motor voltage 410 to the tension motor 108 to apply the tension 406 to the substrate roll 104.

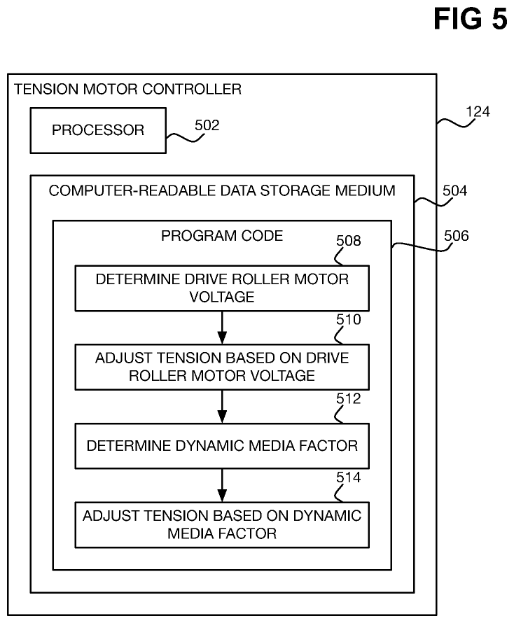

FIG. 5 shows an example of the tension motor controller 124. The tension motor controller 124 includes a processor 502 and a non-transitory computer-readable data storage medium 504 storing program code 506. The processor 502 and the medium 504 may be implemented as discrete components, as is the case with a general-purpose processor and discrete semiconductor memory, or may be implemented in an integrated manner, such as within an ASIC. The program code 506 is executed by the processor 502 to perform processing.

The processing can include determining a signal applied to a drive roller motor to advance a substrate from a roll of substrate through a print zone (508), and adjusting a tension applied by a tension motor to the roll of substrate as wound on a supply roller based on the signal applied to the drive roller motor (510). The processing can additionally or instead include determining a DMF by which the signal applied to the drive roller motor is corrected to compensate for substrate slippage detected by comparing advancement of the substrate through the print zone as detected by an advance sensor and rotation of the drive roller as detected by a drive roller encoder (512). In this case, the processing also includes adjusting the tension applied by the tension motor to the roll of substrate as wound on the supply roller based further on the DMF (514).

Techniques have been described for adjusting the tension applied to a roll of substrate within a printing device that may constitute or be part of a printing system. The tension is adjusted in a closed loop manner, without having to actually measure the actual substrate tension on the substrate. Rather, existing components are leveraged to provide other information, as feedback, that is indirectly indicative of substrate tension. Such information can include a drive roller motor signal, such as voltage or PWM, and/or a DMF that compensates for print substrate slippage.

We claim:

1. A printing device comprising:
a supply roller on which a roll of substrate is wound;
a tension motor to apply a tension to the roll of substrate;
a drive roller to advance the substrate from the roll through a print zone;
a drive roller motor to rotate the drive roller;
a drive roller motor controller to apply a drive roller motor signal to the drive roller motor to realize a specified drive roller speed; and
a closed loop tension controller to adjust the tension applied by the tension motor to the roll of substrate based on the drive roller motor signal applied to the drive roller motor.

2. The printing device of claim 1, wherein the closed loop tension controller is to adjust the tension without receiving a measured signal directly indicative of the tension.

3. The printing device of claim 1, wherein the closed loop tension controller is to adjust the tension applied by the tension motor to the roll of substrate based on the drive roller motor signal to compensate for variability resulting from a change in radius of the roll as the substrate is advanced from the roll through the print zone over time.

4. The printing device of claim 3, wherein the closed loop tension controller is to generate a compensation coefficient based on the drive roller motor signal and is to multiply a target tension by the compensation coefficient to yield the tension that the tension motor is to apply to the roll of substrate.

5. The printing device of claim 1, wherein the closed loop tension controller is to adjust the tension applied by the tension motor to the roll of substrate based on the drive roller motor signal to compensate for periodic variability resulting from eccentricity of the roll.

6. The printing device of claim 5, wherein the closed loop tension controller is to generate a compensation value based on the drive roller motor signal and is to add the compensation value to a target tension to yield the tension that the tension motor is to apply to the roll of substrate.

7. The printing device of claim 1, further comprising:
a drive roller encoder to detect rotation of the drive roller; and
an advance sensor to detect advancement of the substrate through the print zone,
wherein the drive roller motor signal is corrected by a dynamic media factor to compensate for substrate slippage detected by comparing the detected advancement of the substrate with the detected rotation of the drive roller.

8. The printing device of claim 7, wherein the closed loop tension controller is further to adjust the tension applied by the tension motor to the roll of substrate based on the dynamic media factor compensating for the substrate slippage.

9. The printing device of claim 8, wherein the closed loop tension controller is to adjust the tension applied by the tension motor to the roll of substrate based on the dynamic media factor to compensate for variability resulting from a change in radius of the roll as the substrate is advanced from the roll through the print zone over time.

10. The printing device of claim 9, wherein the closed loop tension controller is to generate a compensation coefficient based on the dynamic media factor and is to multiply a target tension by the compensation coefficient to yield the tension that the tension motor is to apply to the roll of substrate.

11. The printing device of claim 8, wherein the closed loop tension controller is to adjust the tension applied by the tension motor to the roll of substrate based on the dynamic media factor to compensate for periodic variability resulting from eccentricity of the roll.

12. The printing device of claim 11, wherein the closed loop tension controller is to generate a compensation value based on the dynamic media factor and is to add the compensation value to a target tension to yield the tension that the tension motor is to apply to the roll of substrate.

13. A non-transitory computer-readable data storage medium storing program code executable by a printing device to perform processing comprising:
determining a signal applied to a drive roller motor to advance a substrate from a roll of substrate through a print zone; and
adjusting a tension applied by a tension motor to the roll of substrate as wound on a supply roller based on the signal applied to the drive roller motor.

14. The non-transitory computer-readable data storage medium of claim 13, wherein the processing further comprises:
determining a dynamic media factor by which the signal applied to the drive roller motor is corrected to compensate for substrate slippage detected by comparing advancement of the substrate through the print zone as detected by an advance sensor and rotation of the drive roller as detected by a drive roller encoder; and
adjusting the tension applied by the tension motor to the roll of substrate as wound on the supply roller based further on the dynamic media factor.

15. A controller device comprising:
a processor; and
a non-transitory computer-readable data storage medium storing program code executable by the processor to perform processing comprising one or both of:
determining a signal applied to a drive roller motor to advance a substrate from a roll of substrate through a print zone, and adjusting a tension applied by a tension motor to the roll of substrate as wound on a supply roller based on the signal applied to the drive roller motor;
determining a dynamic media factor by which the signal applied to the drive roller motor is corrected to compensate for substrate slippage detected by comparing advancement of the substrate through the print zone as detected by an advance sensor and rotation of the drive roller as detected by a drive roller encoder, and adjusting the tension applied by the tension motor to the roll of substrate as wound on the supply roller based further on the dynamic media factor.
